(19) United States
(12) Patent Application Publication
(10) Pub. No.: US 2013/0084087 A1
(43) Pub. Date: Apr. 4, 2013

(54) IMAGE PROCESSING APPARATUS, CONTROL METHOD THEREOF AND COMPUTER-READABLE MEDIUM

(71) Applicant: Sanae Ikeda, Yokohama-shi (JP)

(72) Inventor: Sanae Ikeda, Yokohama-shi (JP)

(73) Assignee: CANON KABUSHIKI KAISHA, Tokyo (JP)

(21) Appl. No.: 13/603,947

(22) Filed: Sep. 5, 2012

(30) Foreign Application Priority Data
Sep. 30, 2011 (JP) 2011-218326

(51) Int. Cl. G03G 15/00; G03G 15/20; G03G 15/08

(52) U.S. Cl. 399/38; 399/67; 399/69; 399/53

(57) ABSTRACT

An image processing apparatus, which controls a fixing temperature and a fixing speed of a fixing device used to fix a formed image, and a color material amount used to form the image, the apparatus comprises: a display unit configured to display an operation panel which accepts settings associated with the fixing temperature, the fixing speed, and the color material amount for image forming processing; and a determination unit configured to determine, in a case where settings of two items out of the fixing temperature, the fixing speed, and the color material amount are accepted via the operation panel, a setting of the remaining one item.

### BACKGROUND OF THE INVENTION

1. Field of the Invention

The present invention relates to an image processing apparatus which executes temperature adjustment of a fixing device in a case where a toner image formed by an electrophotography method is thermally fixed on a transfer sheet and a control method thereof, and a computer-readable medium.

2. Description of the Related Art

In an image forming apparatus which thermally fixes a toner image formed by an electrophotography method on a transfer sheet, a fixing temperature in a fixing device is determined according to an amount of toner per unit area to be applied on the transfer sheet. Normally, a maximum value of an amount of toner per unit area is determined in advance, and temperature adjustment is done to attain a fixing temperature at which an image having the maximum value can be surely fixed.

In a full-color copying machine, since an image is formed by superposing a plurality of toners such as C, M, Y, and K (cyan, magenta, yellow, and black) toners, an amount of toner to be applied on the transfer sheet (to be referred to as an amount of applied toner hereinafter) tends to increase. For this reason, a required heat capacity of a fixing roller becomes large, and in a case where the temperature of the fixing device is lower than a predetermined setting temperature after power-ON or at a wakeup timing from a sleep state, a fixing warm-up time required until the temperature increases to the predetermined setting temperature is prolonged. As a result, a waiting time until the beginning of a print operation is unwantedly generated. Depending on the images to be output, an image which largely falls below the assumed maximum value of the amount of applied toner may be output. For example, upon outputting an image in a monochrome mode using only a K toner, excessive heating is executed, thus wasting electric power.

To solve these problems, the following method has been proposed. This apparatus has a heat roller fixing device which requires a pre-heating operation in a standby state, an operation panel which can switch to an energy-saving mode and can change a shift time, and a control unit which switches ON/OFF of a pre-heating mode of the heat roller fixing device. The control unit switches ON/OFF of the pre-heating mode of the heat roller fixing device based on the shift time to the energy-saving mode, which is set on the operation panel (Japanese Patent Laid-Open No. 2008-281607). By switching fixing temperature control, the “energy-saving mode” which reduces a power consumption amount compared to a case in which a normal fixing temperature is maintained all the time can be realized.

However, the fixing temperature control by the aforementioned method is normally executed while actual fixing processing is not executed, and an energy-saving effect is low in view of the overall print operation. On the other hand, since an appropriate fixing temperature depends on an amount of applied toner and fixing speed of an image, as described above, only the fixing temperature cannot be simply lowered when the “energy-saving mode” is set.

For example, when fixing processing is executed at a temperature lower than a predetermined temperature, it is executed at a speed lower than a predetermined fixing speed, thus guaranteeing the fixing result with the same amount of applied toner as that at the predetermined fixing temperature. However, when the fixing speed is changed, since a toner melting state on a printing medium changes, texture (glossiness or the like) of an output image often changes. When fixing processing is executed at a temperature lower than the predetermined temperature and at the predetermined speed, the fixing result can be guaranteed by correcting image data to reduce an amount of applied toner. However, when the amount of applied toner of an image is reduced, a color depth is normally lost, resulting in low image quality.

In this manner, since lowering of the fixing temperature leads to a reduction of power consumption, it can be used as an environmentally friendly function such as the “energy-saving mode”. However, the fixing temperature, fixing speed, and amount of applied toner on an image are correlated, only the fixing temperature cannot be independently lowered.

Furthermore, the user cannot easily recognize relevancies about influences and merits/demerits among the power consumption (fixing temperature), print speed (fixing speed), and image quality (amount of applied toner) as performances of the apparatus.

Furthermore, only the method for switching ON/OFF of the “energy-saving mode” does not allow the user to select which of these apparatus performances is to be prioritized.

### SUMMARY OF THE INVENTION

According to one aspect of the present invention, there is provided an image processing apparatus, which controls a fixing temperature and a fixing speed of a fixing device used to fix a formed image, and a color material amount used to form the image, the apparatus comprising: a display unit configured to display an operation panel which accepts settings associated with the fixing temperature, the fixing speed, and the color material amount for image forming processing; and a determination unit configured to determine, in a case where settings of two items out of the fixing temperature, the fixing speed, and the color material amount are accepted via the operation panel, a setting of the remaining one item.

According to another aspect of the present invention, there is provided an image processing apparatus, which controls a fixing temperature and a fixing speed of a fixing device used to fix a formed image, and a color material amount used to form the image, the apparatus comprising: a display unit configured to display an operation panel which accepts settings associated with the fixing temperature, the fixing speed, and the color material amount for image forming processing; a determination unit configured to determine, in a case where a setting of one item out of the fixing temperature, the fixing speed, and the color material amount are accepted via the operation panel, setting ranges of setting values of the remaining two items; and a control unit configured to control displayed contents of the operation panel by the display unit so as not to allow to select setting values falling outside the setting ranges determined by the determination unit.

According to another aspect of the present invention, there is provided a control method in an image processing apparatus, which controls a fixing temperature and a fixing speed of a fixing device used to fix a formed image, and a color material amount used to form the image, the method comprising the steps of: displaying an operation panel which accepts settings associated with the fixing temperature, the fixing speed, and the color material amount for image forming processing; and determining, in a case where settings of two items out of the fixing temperature, the fixing speed, and the color material amount are accepted via the operation panel, a setting of the remaining one item.

According to another aspect of the present invention, there is provided a control method in an image processing apparatus, which controls a fixing temperature and a fixing speed of a fixing device used to fix a formed image, and a color material amount used to form the image, the method comprising the steps of: displaying an operation panel which accepts settings associated with the fixing temperature, the fixing speed, and the color material amount for image forming processing; determining, in a case where a setting of one item out of the fixing temperature, the fixing speed, and the color material amount are accepted via the operation panel, setting ranges of setting values of the remaining two items; and controlling displayed contents of the operation panel in the display step so as not to allow to select setting values falling outside the setting ranges determined in the determination step.

According to another aspect of the present invention, there is provided a non-transitory computer-readable medium storing a program for controlling a computer to function as: a display unit configured to display an operation panel which accepts settings associated with a fixing temperature, a fixing speed, and a color material amount for image forming processing; and a determination unit configured to determine, in a case where settings of two items out of the fixing temperature, the fixing speed, and the color material amount are accepted via the operation panel, a setting of the remaining one item.

According to another aspect of the present invention, there is provided an non-transitory computer-readable medium storing a program for controlling a computer to function as: a display unit configured to display an operation panel which accepts settings associated with a fixing temperature, a fixing speed, and a color material amount for image forming processing; a determination unit configured to determine, in a case where a setting of one item out of the fixing temperature, the fixing speed, and the color material amount are accepted via the operation panel, setting ranges of setting values of the remaining two items; and a control unit configured to control displayed contents by the display unit so as not to allow to select setting values falling outside the setting ranges determined by the determination unit.

The present invention allows the user to set which of a plurality of elements which influence the processing performance of a fixing device and energy-saving efficiency and are correlated with each other is to be prioritized in consideration of their correlation within possible ranges.

Further features of the present invention will become apparent from the following description of exemplary embodiments (with reference to the attached drawings).

### BRIEF DESCRIPTION OF THE DRAWINGS

FIG. 1 is a schematic block diagram showing the arrangement of an image forming apparatus;

FIG. 2 is a block diagram showing the detailed arrangement of the image forming apparatus;

FIG. 3 is a schematic view of the image forming apparatus;

FIGS. 4A, 4B, and 4C are graphs showing the relationship among a fixing temperature, fixing speed, and maximum amount of applied toner according to the first embodiment;

FIGS. 5A and 5B are views showing a configuration example of a first menu according to the first embodiment;

FIGS. 6A and 6B are flowcharts showing the sequence of processing according to the first embodiment;

FIGS. 7A, 7B, 7C, 7D, and 7E are views showing a configuration example of setting value correlation tables;

FIG. 8 is a flowchart showing the sequence of processing according to the second embodiment;

FIGS. 9A, 9B, 9C, 9D, 9E, 9F, and 9G are views showing a configuration example of a second menu according to the second embodiment;

FIGS. 10A, 10B, 10C, 10D, and 10E are views showing a configuration example of setting value correlation tables according to the second embodiment;

FIGS. 11A, 11B, and 11C are views showing a configuration example of setting value correlation tables according to the second embodiment;

FIGS. 12A, 12B, and 12C are flowcharts showing the sequence of processing according to the third embodiment;

FIGS. 13A and 13B are views showing a configuration example of a first menu according to the third embodiment;

FIGS. 14A, 14B, 14C, and 14D are views showing a configuration example of a third menu according to the third embodiment;

FIGS. 15A, 15B, and 15C are views showing an example of respective menus and setting value correlation tables according to the third embodiment; and

FIGS. 16A, 16B, 16C, and 16D are views showing an example of respective menus and setting value correlation tables according to the third embodiment.

### DESCRIPTION OF THE EMBODIMENTS

Embodiments for carrying out the invention of the present invention will be described hereinafter with reference to the drawings.

### First Embodiment

[Arrangement of Image Forming Apparatus]

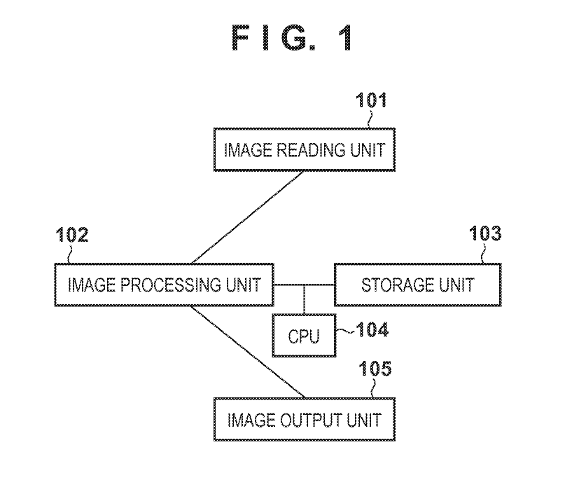

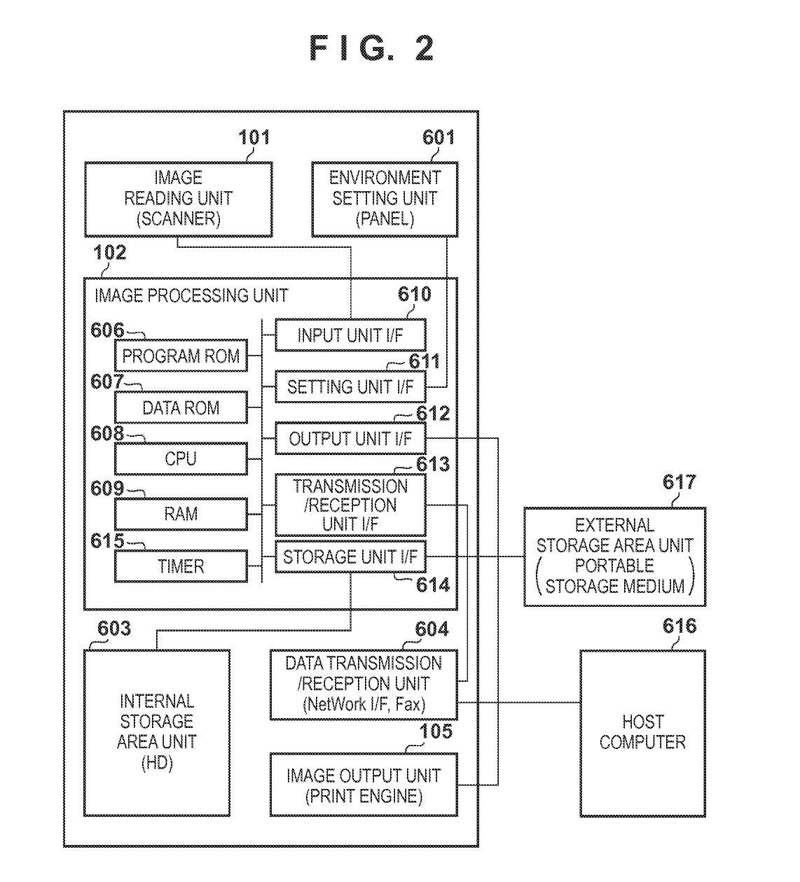

FIGS. 1 and 2 are block diagrams showing the arrangement of an image forming apparatus which executes image forming processing based on an electrophotography method according to this embodiment. As shown in FIG. 1, the image forming apparatus includes an image reading unit 101, image processing unit 102, storage unit 103, CPU 104, and image output unit 105. Note that the image forming apparatus according to this embodiment can be connected to external apparatuses such as a server which manages image data and a personal computer (PC) which issues a print execution instruction via a network.

The image reading unit 101 reads an image on a document, and outputs image data. The image processing unit 102 converts print information including image data input from the image reading unit 101 or externally input image data into intermediate information (to be referred to as objects hereinafter), and stores the converted information in an object buffer of the storage unit 103. Furthermore, the image processing unit 102 (image processing apparatus) generates bitmap data based on the buffered objects, and stores the generated data in a buffer of the storage unit 103. In this case, the image processing unit 102 executes color conversion processing, image adjustment processing, total toner amount control processing, and the like. Details will be described later.

The storage unit 103 includes a ROM, RAM, hard disk (HD), and the like. The ROM stores various control programs and image processing programs to be executed by the CPU 104. The RAM is used as a reference area and work area in which the CPU 104 stores data and various kinds of information. Also, the RAM and HD are used as the aforementioned object buffer and a storage area used to store setting values of a fixing temperature (to be described later) and the like.

The image forming apparatus stores image data on this RAM and HD, sorts pages, stores a plurality of sorted document pages, and prints out a plurality of copies. The image output unit 105 forms and outputs a color image on a printing medium such as a printing sheet.

The arrangement of the image forming apparatus will be described in more detail below with reference to FIG. 2. Image data read by the image reading unit 101 is supplied to the image processing unit 102 via an input unit I/F 610. A CPU 608 launches a data processing program stored in a program ROM 606, and processes the supplied data on a RAM 609 using processing data stored in a data ROM 607. Image data which is being processed or after processing is stored as needed in an internal storage area unit 603 via a storage unit I/F 614.

The image data which has undergone the processing is sent to a data transmission/reception unit 604 via an transmission/reception unit I/F 613 or the image output unit 105 via an output unit I/F 612. The data sent to the data transmission/reception unit 604 is sent to another externally connected data processing apparatus such as a host computer 616 on the network. The data sent to the image output unit 105 is printed out from a print engine included in the image forming apparatus on a medium such as a paper sheet. Print data is often received from the external host computer 616 via this data transmission/reception unit 604. At this time, the image forming apparatus serves as a printer. Furthermore, the image forming apparatus often directly inputs data by attaching a portable external storage area 617 such as a USB memory to the storage unit I/F 614.

The user sets an operation environment upon execution of processing for a series of print data from an environment setting unit (panel) 601. The operation settings of the image processing unit 102 are made via a setting unit I/F 611 according to the setting contents.

Note that the storage unit 103 in FIG. 1 corresponds to respective storage units such as the internal storage area unit 603 shown in FIG. 2. Also, FIG. 2 illustrates that the CPU 608 is included in the image processing unit 102, but the present invention is not limited to such specific arrangement.

[Apparatus Overview]

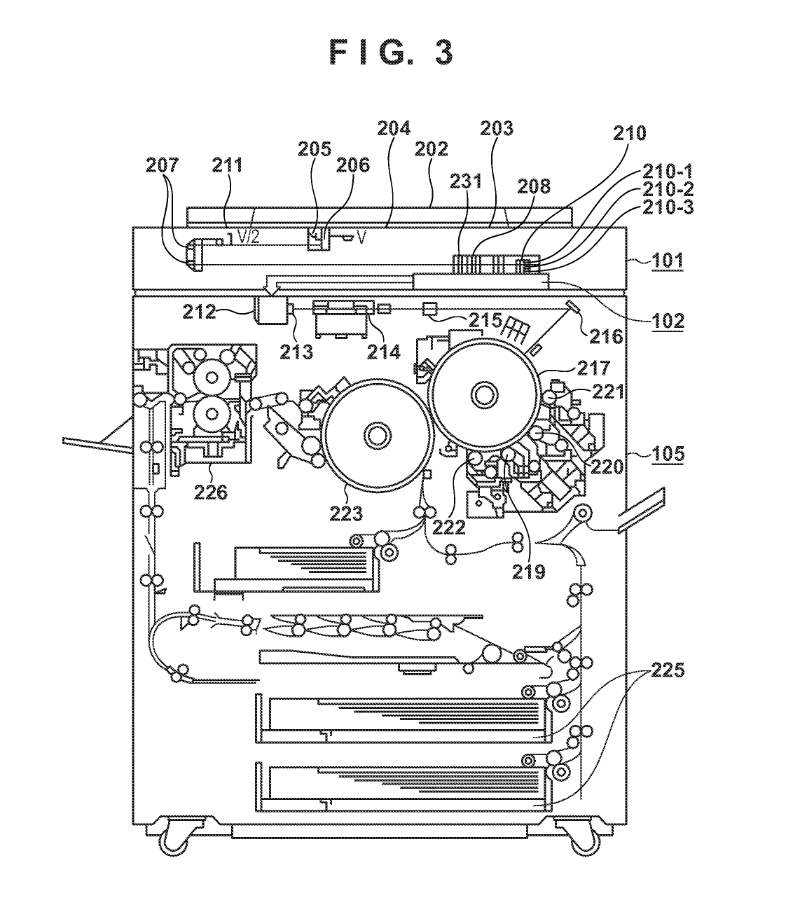

FIG. 3 shows an overview of the image forming apparatus. In the image reading unit 101, a document 204 from which an image is to be read is placed between a platen glass 203 and document pressing plate 202, and is irradiated with light coming from a lamp 205. Reflected light from the document 204 is guided by mirrors 206 and 207, and forms an image on a 3-line sensor 210 via a lens 208. Note that an infrared cut filter 231 is provided to the lens 208. A motor (not shown) moves a mirror unit including the mirror 206 and lamp 205 at a velocity V, and a mirror unit including the mirrors 207 at a velocity V/2 in a direction of the arrow. That is, the mirror units are moved in a direction (sub-scanning direction) perpendicular to an electrical scanning direction (main scanning direction) of the 3-line sensor 210, thereby scanning the entire surface of the document 204.

The 3-line sensor 210 including three lines of CCDs color-separates input optical information to read color components of full-color information RGB (red, green, and blue), and sends the color component signals to the image processing unit 102. In this embodiment, each of the CCDs included in the 3-line sensor 210 has light-receiving elements for 5000 pixels. The 3-line sensor 210 can read a widthwise direction (297 mm) of an A3-size document as a maximum size of a document which can be placed on the platen glass 203 at a resolution of 600 dpi.

A standard white plate 211 is used to correct data read by CCDs 210-1 to 210-3 included in the 3-line sensor 210. The standard white plate 211 is white which exhibits nearly uniform reflection characteristics under visible light.

The image processing unit 102 electrically processes an image signal input from the 3-line sensor 210 to generate C, M, Y, and K (cyan, magenta, yellow, and black) color component signals. The image processing unit 102 sends the generated C, M, Y, and K color component signals to the image output unit 105. Images output at this time are C, M, Y, and K images which have undergone halftone processing such as dithering.

In the image output unit 105, the C, M, Y, or K image signal sent from the image reading unit 101 is sent to a laser driver 212. The laser driver 212 modulates and drives a semiconductor laser element 213 according to the input image signal. A laser beam output from the semiconductor laser element 213 scans a surface of a photosensitive drum 217 via a polygonal mirror 214, f-θ lens 215, and mirror 216, thereby forming an electrostatic latent image on the photosensitive drum 217.

Developers include a magenta developer 219, cyan developer 220, yellow developer 221, and black developer 222. The four developers are alternately brought into contact with the photosensitive drum 217 to develop an electrostatic latent image formed on the photosensitive drum 217 with a toner of a corresponding color, thus forming a toner image. A printing sheet fed from a paper cassette 225 is wound around a transfer drum 223, thus transferring each toner image on the photosensitive drum 217 onto the printing sheet. The printing sheet on which toner images of four colors C, M, Y, and K are sequentially transferred passes through a fixing unit 226 as a fixing device, thus thermally fixing the toner images. After that, the printing sheet is discharged outside the image forming apparatus. The fixing unit 226 applies a pressure and heat from an internal pressing roller to the printing sheet, thereby fixing the toner images of four colors C, M, Y, and K on the printing sheet. When a heat amount at that time is insufficient for an amount of applied toner, a fixing error occurs, and a normal image cannot be obtained. For this reason, a temperature sensor (not shown) is attached to the fixing unit 226, which is controlled to execute a fixing operation only when a predetermined temperature high enough to fix the toner images is confirmed. This temperature control is executed by the CPU 104 based on the relationship between the temperature sensor information and amount of applied toner.

[Relationship between Amount of Applied Toner and Fixing Temperature]

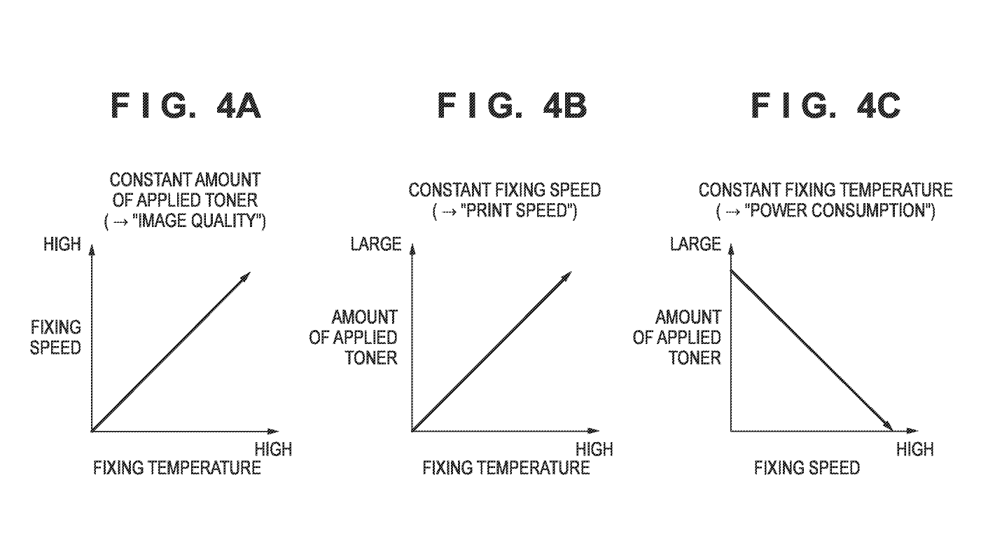

The relationship among a print mode related to the aforementioned amount of applied toner, a required temperature (to be referred to as a fixing temperature hereinafter) and processing speed (to be referred to as a fixing speed hereinafter) of the fixing unit will be described below with reference to FIGS. 4A to 4C.

The amount of applied toner indicates that per unit area on an image, and will be explained to have % as a unit. More specifically, assuming that a maximum of each of colors C, M, Y, and K is 100%, when, for example, the maximum values for two colors are overlaid, an amount of applied toner of 200% is defined on that area. Since each color has tonality, it can assume a value ranging from 0 to 100%. This amount of applied toner influences quality of a printed image. In this case, settings (print modes) for quality of a printed image according to this embodiment will be described below.

For example, a full-color print mode fully uses toners of four colors C, M, Y, and K, reproduces an arbitrary color within a reproduction range of these toners, and attains high-quality color print processing. In this embodiment, when about 240% is assured as a maximum amount of applied toner in the full-color print mode, an image with high quality can be obtained.

A UCR (Under Color Removal) print mode executes processing for replacing black or gray formed by three colors C, M, and Y in the above full-color mode by K alone to enhance readability of characters by suppressing toner scatterings of characters and thin lines. In the UCR print mode, since C, M, and Y toners are replaced by a K toner, the maximum amount of applied toner is reduced. In this embodiment, the maximum amount of applied toner in the UCR print mode suffices to be about 180%.

Also, a toner-saving print mode prints an image by reducing an amount of applied toner to be used by decreasing a density of the image with respect to the full-color mode. In this embodiment, since the toner-saving mode halves the toners to be used compared to those in the full-color mode, a maximum value is also defined as 120% as a half of that in the full-color mode.

Finally, a single-color print mode executes processing using only a toner of one color represented by monochrome print processing. In this embodiment, a maximum value in the single-color print mode is 100% as that of the amount of applied toner for one color.

In this manner, the maximum amount of applied toner changes depending on how to process colors of an image, and the required temperature of the fixing unit also changes at that time. The fixing temperature increases in ascending order of the maximum amount of applied toner. That is, when the fixing speed is constant, the relationship among the fixing temperatures of the respective modes meets [full-color print>UCR print>toner-saving print>single-color print].

These relationships between the maximum amounts of applied toner and fixing temperatures are premised on that the operation speed at a fixing timing is constant. When a fixing speed as another element is changed, allowable values of the maximum amounts of applied toner at the same temperature are also changed. That is, when the fixing speed is lower, since a heat amount per unit area during a given time period increases, fixability of a toner with respect to a printing medium is improved. Conversely, when the fixing speed is higher, fixability tends to lower. When the fixing speed is increased, the maximum amount of applied toner can be maintained by raising the fixing temperature for the reason as described above.

In this manner, the fixing temperature, fixing speed, and maximum amount of applied toner are correlated with each other. FIGS. 4A to 4C show this relationship. That is, when the maximum amount of applied toner is kept constant, if the fixing temperature is raised, the fixing speed can also be increased (FIG. 4A). When the fixing speed is constant, if the fixing temperature is raised, the maximum amount of applied toner can be increased (FIG. 4B). When the fixing temperature is constant, if the fixing speed is increased, the maximum amount of applied toner has to be decreased (FIG. 4C). The correspondence relationships expressed in FIGS. 4A to 4C are used when “setting value correlation tables” as correlation information used in control according to this embodiment are generated.

Note that when the maximum amount of applied toner is predicted for a toner amount corresponding to each pixel in an image, the most general prediction method judges that amount based on the aforementioned print modes. That is, the maximum amount of applied toner which is defined in advance in correspondence with the set print mode is specified. When image data is corrected in consideration of the maximum amount of applied toner according to a fixing condition, a method of decreasing a density by image adjustment processing while the print mode is left unchanged may be used in addition to a method of changing the print mode. More specifically, the following method may be used.

The image processing unit 102 executes image adjustment processing. The image processing unit 102 executes adjustment according to an adjustment value from an operation unit in copy processing or that from a printer driver in print processing. In this case, image density adjustment will be exemplified in detail as the image adjustment processing. In this embodiment, a density adjustment value assumes a value ranging from 1 to 9, and an initial setting is 5. As this value is increased from 5, a density of an output image increases; when a value smaller than 5 is set, a density of an output image decreases. As a calculation formula for respective C, M, Y, and K values at this time, letting Cin be an input value and Cout be an output value, that formula is described by:

Cout=Cin×gain+ofst (1)

When the density is increased, the value “gain” assumes a value larger than 1, and “ofst” also assumes a value larger than 0. Conversely, when the density is decreased, “gain” assumes a value smaller than 1, and “ofst” also assumes a value smaller than 0. When no adjustment is applied, gain=1 and ofst=0. By switching the “gain” and “ofst” values according to density adjustment values=1 to 9, density adjustment is implemented. Note that as described above, since each of the input and output values is 8-bit data which assumes a value ranging between 0 to 255, a value when the output value falls below 0 is clipped to 0, and a value when the output value exceeds 255 is clipped to 255.

Calculation formulas for the “gain” and “ofst” values are not particularly limited. Also, calculation formulas for the density adjustment other than equation (1) may be used.

Thus, since the density is lowered while maintaining a ratio of C, M, Y, and K toners, the amount of applied toner can be changed.

[Processing Sequence]

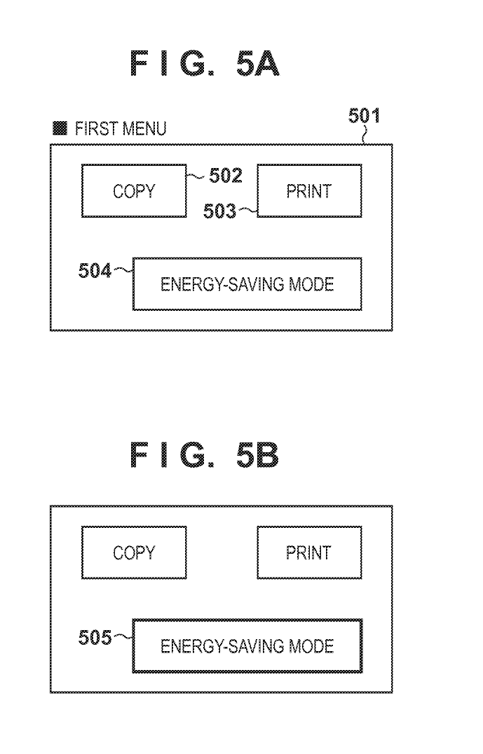

The processing of the first embodiment will be described in detail below with reference to FIGS. 5A to 7E. FIGS. 5A and 5B show a switching menu (to be referred to as a first menu 501 hereinafter) of the [energy-saving mode] displayed on a user interface (to be abbreviated as UI hereinafter) on the environment setting unit 601 included in the image forming apparatus or the connected host computer 616. In the same manner as in normal function menus (copy 502 and print 503) of the image forming apparatus, a state setting menu indicating an energy-saving mode 504 is provided. Upon pressing the energy-saving mode 504, that mode is shifted from a disabled (OFF) state shown in FIG. 5A to an ON (enabled) state shown in FIG. 5B. FIG. 5B shows an energy-saving mode 505 in the ON state. This setting state is referred to first in the processing sequence to be described below. Note that the screen of the first menu is not limited to the configuration shown in FIGS. 5A and 5B, and another display method may be used.

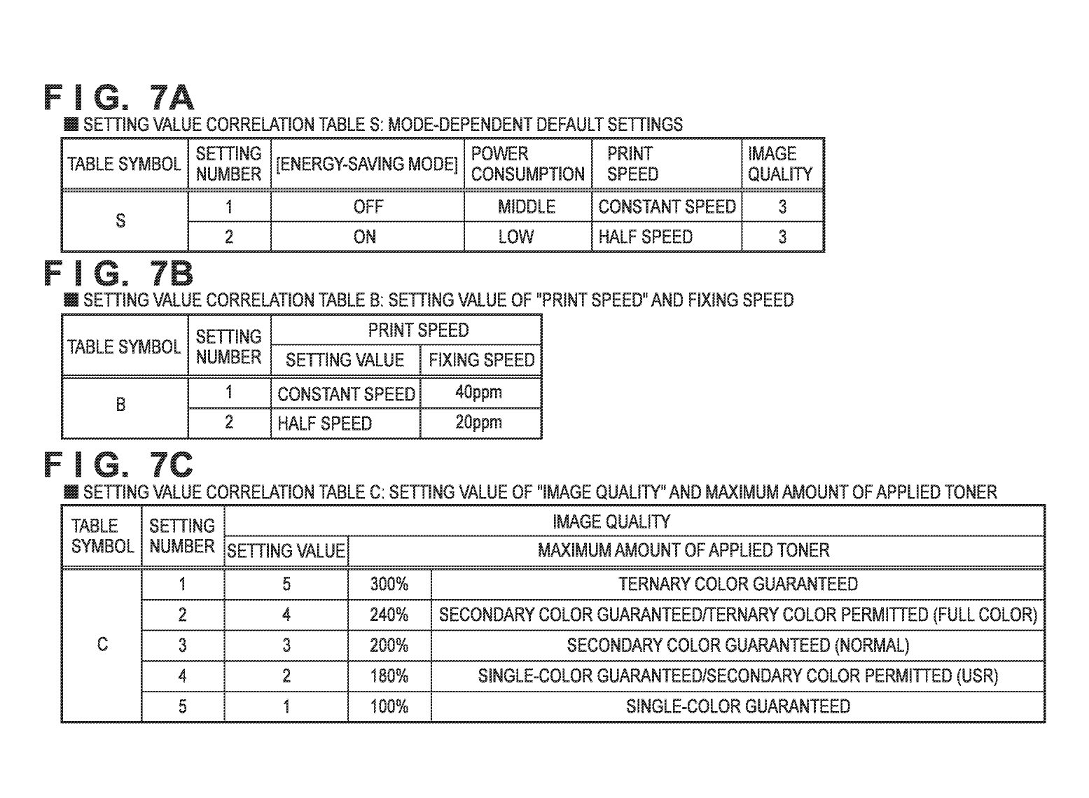

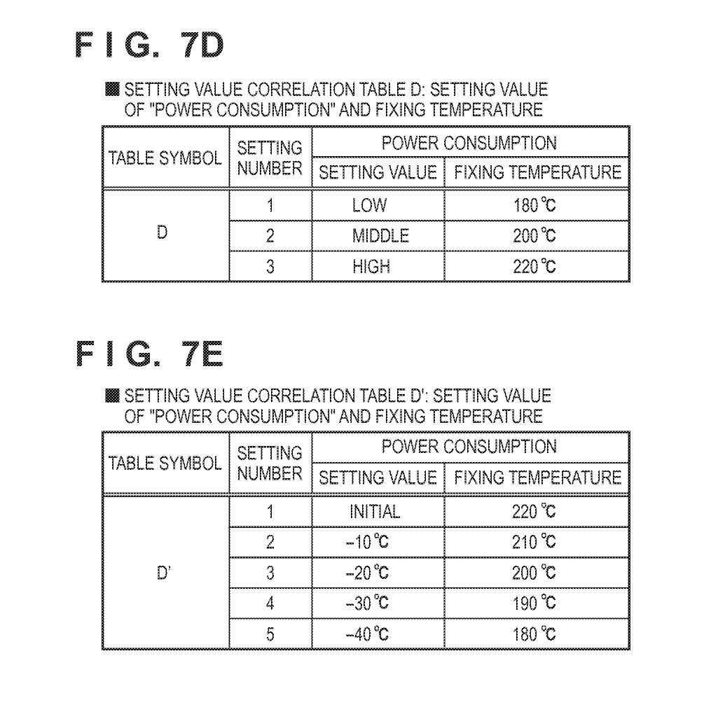

FIG. 7A shows a configuration example of a setting value correlation table S used in this embodiment. This table defines a fixing temperature which can be set by the image forming apparatus, an optimal fixing speed corresponding to the fixing temperature, and a maximum amount of applied toner which can be guaranteed when the apparatus operates at that fixing temperature and speed. This setting value correlation table S is stored and held in advance in the data ROM 607. It is practical to set the setting values which can be assumed by these three elements as combinations of setting values within their settable ranges, which can exhibit the highest processing performance of the image forming apparatus. Note that practical values of the respective elements (fixing temperature, fixing speed, and maximum amount of applied toner) of the setting value correlation table S are defined in advance.

The image forming apparatus includes a plurality of feed units (paper cassette 225 and the like), and the setting value correlation table S may be defined and held for each of the feed units included in the image output unit 105 of the image forming apparatus. In this case, the energy-setting mode settings can be switched depending on the feed units (or types of paper sheets to be fed). For this reason, the following switching operation can be attained. For example, a power consumption level in the energy-saving mode is set to be lower than a normal level for a feed port at which recycled paper sheets are set, and that in the energy-saving mode is set to be higher than a normal level for a feed port at which high-glossy paper sheets are set.

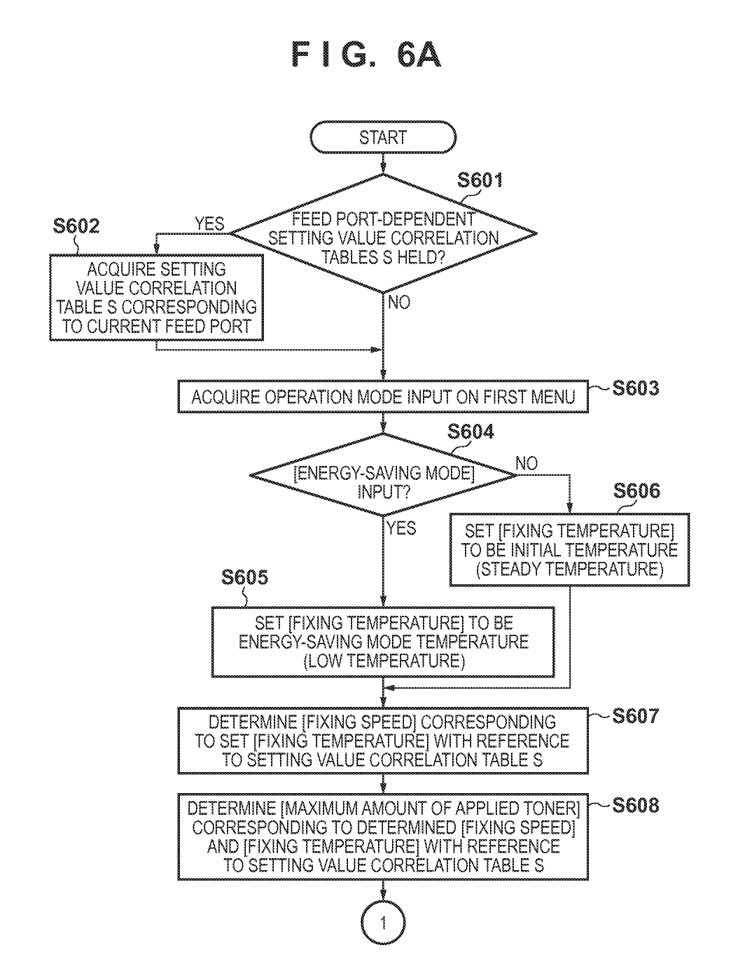

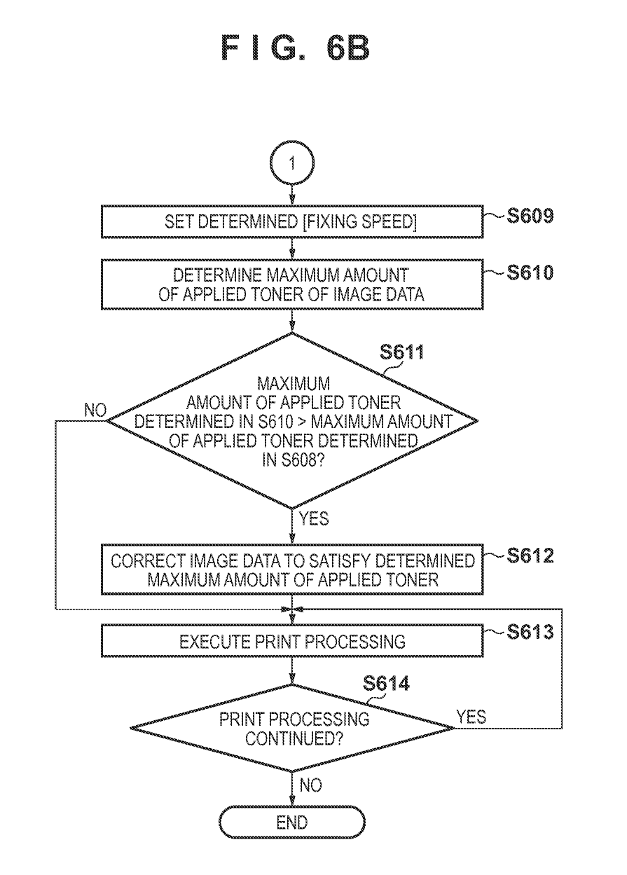

FIGS. 6A and 6B show the processing sequence. The processing shown in the following sequence is processed by the image processing unit 102 based on instructions from the CPU 608. The same applies to other embodiments.

After image data is input from the image reading unit 101 or host computer 616, and print processing is started, the image processing unit 102 judges in step S601 whether or not the setting value correlation tables S are held in correspondence with feed ports of the image output unit 105 of the image forming apparatus. If the feed port-dependent setting value correlation tables S are held (YES in step S601), the image processing unit 102 acquires the setting value correlation table S corresponding to the currently selected feed port in step S602. Then, the process advances to step S603. If the feed port-dependent setting value correlation tables are not held (NO in step S601), the image processing unit 102 uses a default setting value correlation table S.

In step S603, the image processing unit 102 acquires a setting state of the first menu 501. The image processing unit 102 determines in step S604 whether or not the [energy-saving mode] setting is input. If the [energy-saving mode] is not set (NO in step S604), the image processing unit 102 sets a fixing temperature at a temperature in a steady state in step S606. This temperature corresponds to that corresponding to power consumption of a setting number “1” in the setting value correlation table S shown in FIG. 7A. If the [energy-saving mode] is set (YES in step S604), the image processing unit 102 sets a fixing temperature at a temperature (low temperature) in the energy-saving mode state in step S605. This temperature corresponds to that corresponding to power consumption of a setting number “2” in the setting value correlation table S shown in FIG. 7A.

In step S607, the image processing unit 102 determines a fixing speed corresponding to the fixing temperature set in the above step with reference to the setting value correlation table S. In step S608, the image processing unit 102 determines a maximum amount of applied toner corresponding to the determined fixing speed and fixing temperature. Assume that the maximum amount of applied toner is determined from image quality in the setting value correlation table S. In step S609, the image processing unit 102 sets the determined fixing speed.

In step S610, the image processing unit 102 determines a maximum amount of applied toner corresponding to the aforementioned print mode for an output image.

In step S611, the image processing unit 102 compares the maximum amount of applied toner determined in step S610 and that determined in step S608. If the maximum amount of applied toner determined in step S610 exceeds that determined in step S608 (YES in step S611), the image processing unit 102 corrects image data to be equal to or smaller than the maximum amount of applied toner determined in step S608 in step S612. A correction unit uses the aforementioned method using equation (1) or the like. Note that the present invention is not limited to the aforementioned method, and other methods may be used.

In step S613, the image processing unit 102 executes print processing. Furthermore, if there is another image processing target (YES in step S614), the process returns to step S613 to continue the processing. If the print processing ends (NO in step S614), this processing sequence ends.

With this method, the fixing temperature and the fixing speed and maximum amount of applied toner, which are correlated with the fixing temperature, are set in the energy-saving mode.

As described above, the user can select which of a plurality of elements, which influence the processing performance and energy-saving efficiency of the image forming apparatus and are correlated with each other, is to be prioritized within a possible range while maintaining the correlation.

### Second Embodiment

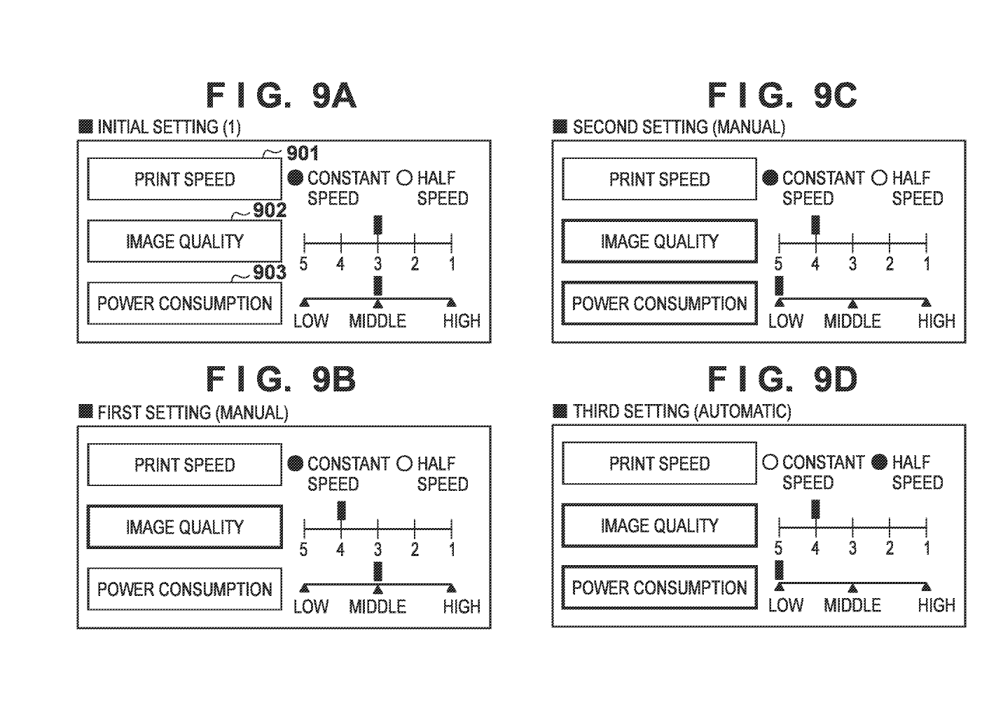

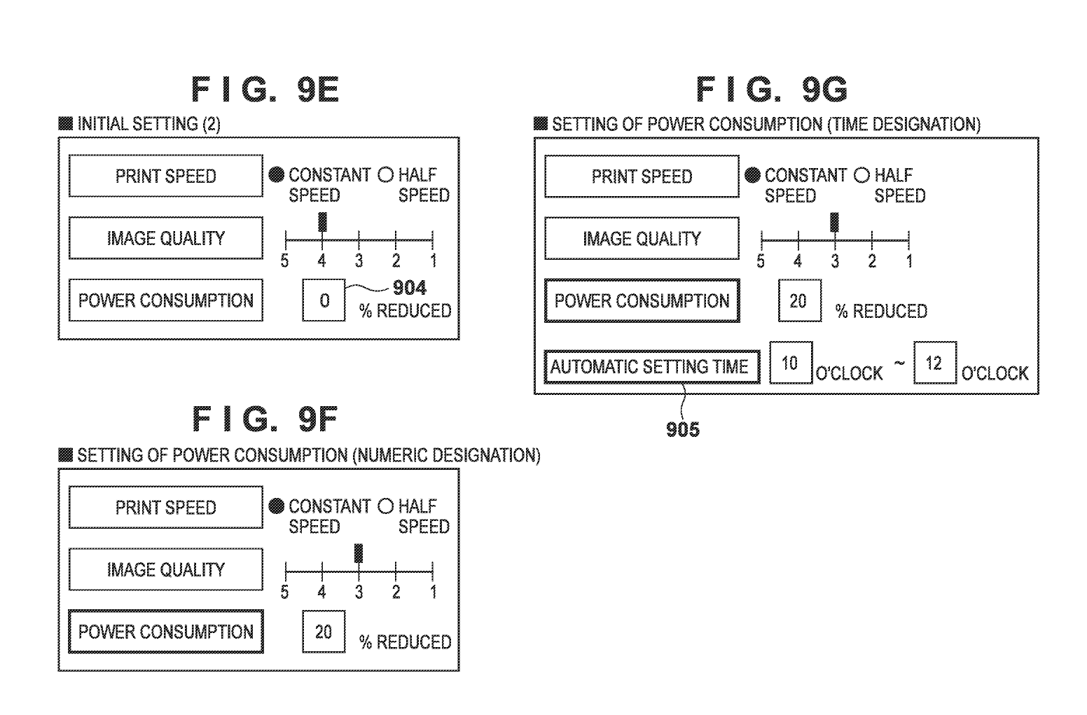

Processing of the second embodiment will be described in detail below with reference to FIGS. 7A to 10E. FIGS. 9A to 9G show a switching menu (to be referred to as a second menu hereinafter) of elements associated with the processing performance of the image forming apparatus, which menu is displayed on the UI of the environment setting unit 601 included in the image forming apparatus or the connected host computer 616. In this embodiment, setting elements included in the second menu are [print speed] and [image quality], and an element [power consumption] associated with an energy-saving level of the image forming apparatus.

FIG. 9A shows an initial setting as a state setting menu of the image forming apparatus. The setting elements displayed within the menu are correlated with each other, and when one of the three elements is determined, the setting ranges of the remaining two elements may be restricted in any way. Furthermore, when two out of the three elements are determined, the remaining one element is uniquely determined. From the initial state shown in FIG. 9A, a state can be changed by pressing a menu button of the [image quality] element (in this case, a fixed value is set) or operating a slide bar (in this case, the user can select a level). FIG. 9A shows menu buttons as a print speed button 901, image quality button 902, and power consumption button 903. In this configuration, the print speed is set using radio buttons, and the image quality and power consumption are set using slide bars.

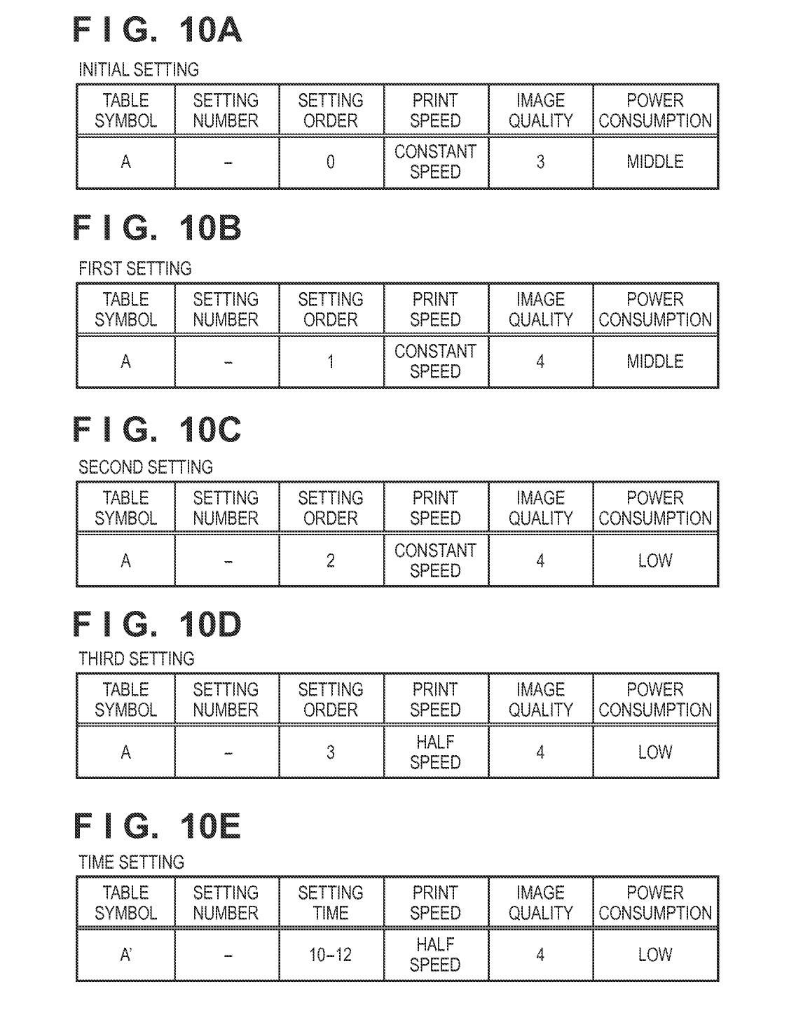

For example, when the initial state changes to a state shown in FIG. 9B, a setting value of [image quality] is stored in a setting value correlation table A shown in FIGS. 10A to 10E as “first setting” in the RAM 609, internal storage area unit 603, or the like. Note that FIG. 10A defines initial values of the setting value correlation table A. However, the present invention is not limited to these values, and for example, the user can arbitrarily define the initial values. In this example, the table contents are written from the initial settings shown in FIG. 10A to a state shown in FIG. 10B. When settable ranges of setting values of the remaining two elements are changed according to the first setting value, the setting ranges on the UI are changed as needed. Likewise, when a state of the [power consumption] element changes to that shown in FIG. 9C, the setting value of [power consumption] is similarly stored in the setting value correlation table A as “second setting”, as shown in a state of FIG. 10C. After the first and second setting values are settled, the third setting value is automatically set, as shown in a state of FIG. 10D. Then, the UI is updated to a state shown in FIG. 9D since the determined setting values are reflected to the displayed contents.

At this time, the respective setting values and actual operations and states of the image forming apparatus are specified by setting value correlation tables B to D shown in FIGS. 7B to 7D. A setting value correlation table B shown in FIG. 7B specifies [print speed] and, for example, a normal operation speed (constant speed) and special operation speed (half speed) are respectively associated with fixing speeds of 40 ppm and 20 ppm. The fixing speed is switched depending on, for example, a property of a printing medium and a printing environment.

A setting value correlation table C shown in FIG. 7C specifies [image quality], and a maximum amount of applied toner to be guaranteed is switched in this table. In this example, five levels from 100% as single-color guaranteed to 300% as ternary color guaranteed are provided. As options of the maximum amount of applied toner, for example, it is practical to specify the amount of applied toner according to the print mode, as described in the first embodiment. Furthermore, a setting value correlation table D shown in FIG. 7D specifies [power consumption], and a fixing temperature is switched in this table. This option is calculated from the fixing speed and maximum amount of applied toner.

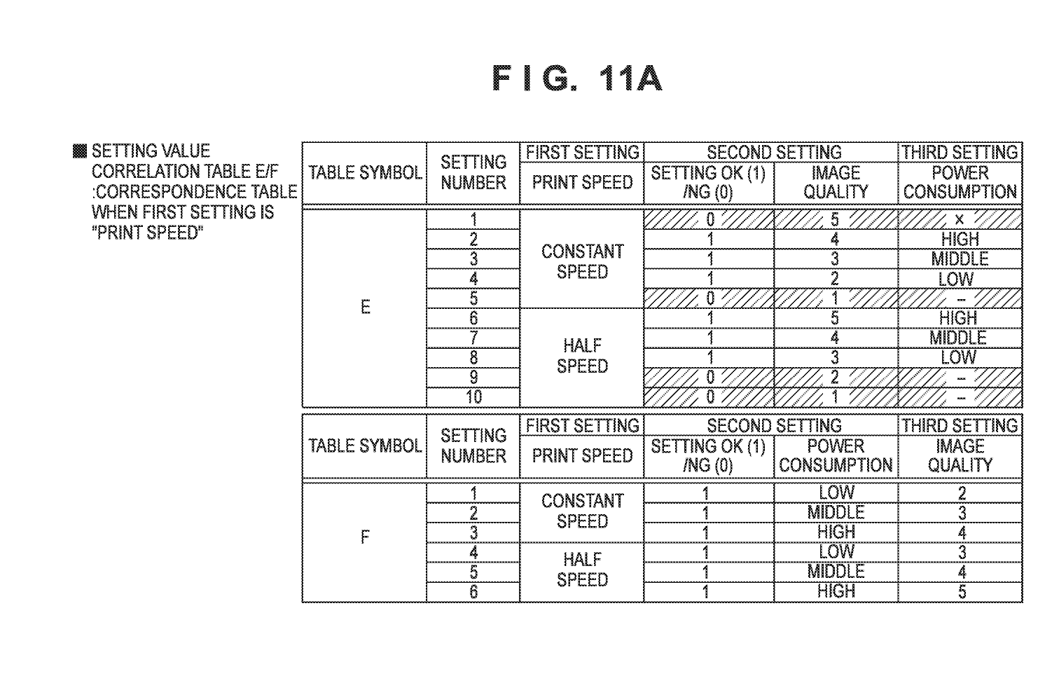

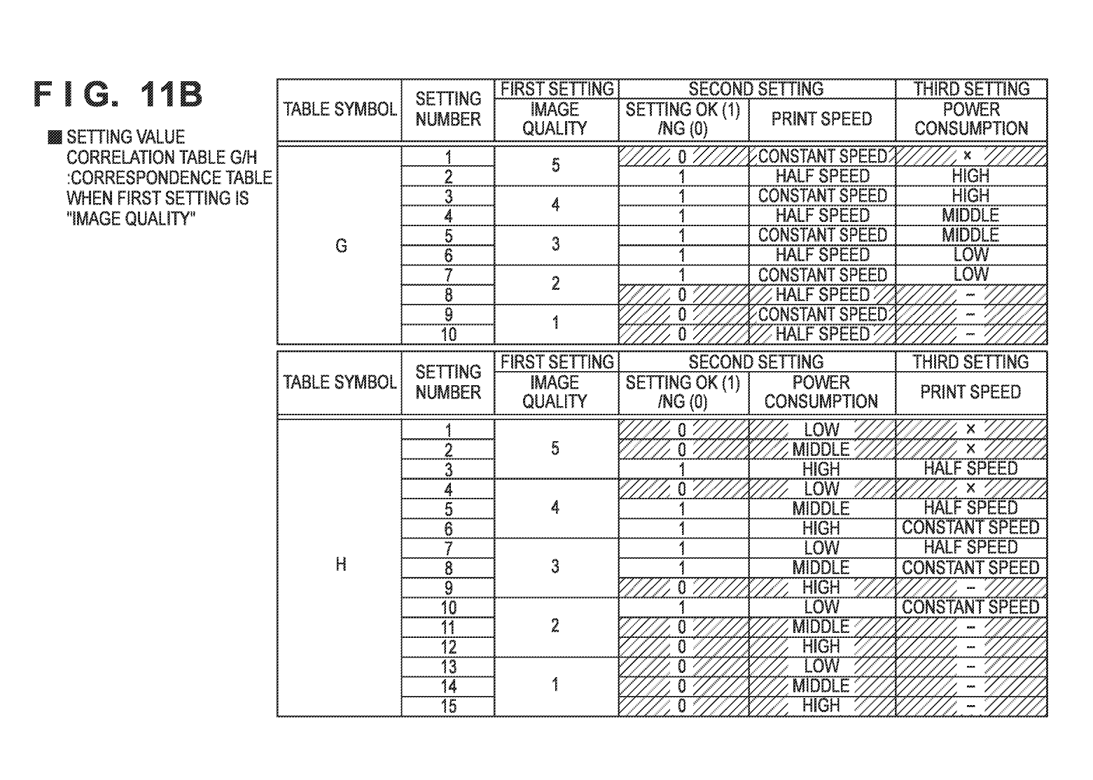

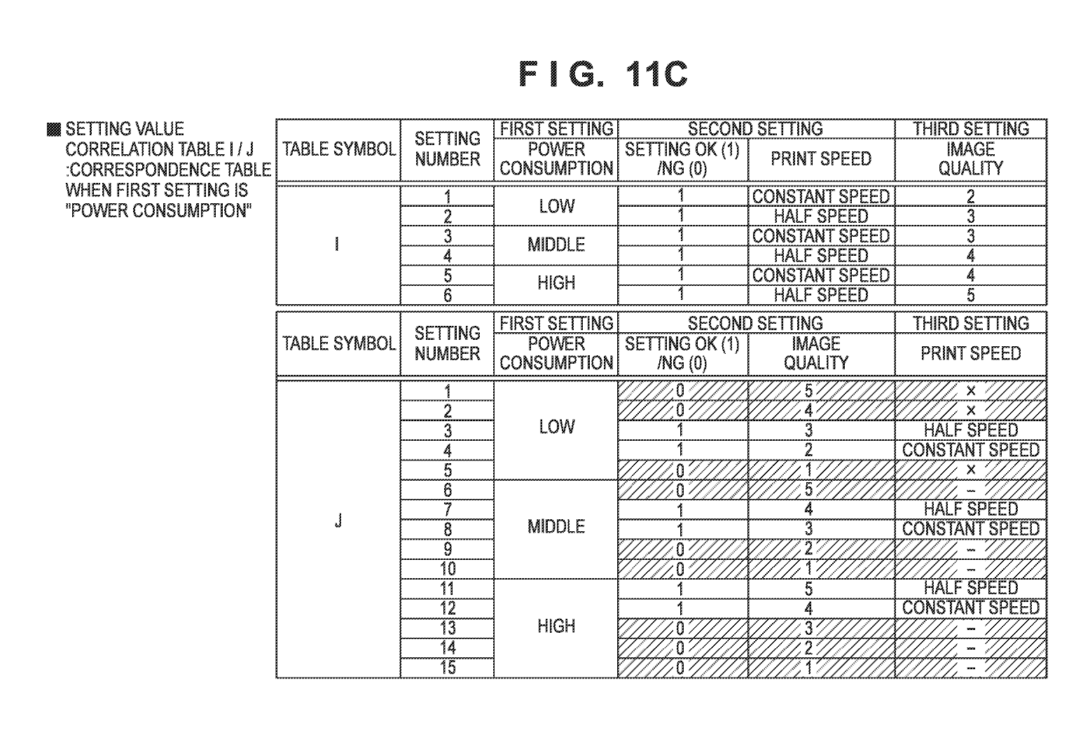

The correlations among these three elements are specified by setting value correlation tables E to J shown in FIGS. 11A to 11C. A setting value correlation table E/F shown in FIG. 11A specifies setting value associations when the first setting is [print speed] and when the second setting is [image quality] and the third setting is [power consumption] in the table E. Likewise, the table F specifies setting value associations when the second setting is [power consumption] and the third setting is [image quality].

A setting value correlation table G/H shown in FIG. 11B specifies setting value associations when the first setting is [image quality] and when the second setting is [print speed] and the third setting is [power consumption] in the table G. Likewise, the table H specifies setting value associations when the second setting is [power consumption] and the third setting is [print speed].

A setting value correlation table I/J shown in FIG. 11C specifies setting value associations when the first setting is [power consumption] and when the second setting is [print speed] and the third setting is [image quality] in the table I. Likewise, the table J specifies setting value associations when the second setting is [image quality] and the third setting is [print speed].

In FIGS. 11A to 11C, the third setting, which can be assumed when the second setting is determined, is associated with the first setting, and restrictions of the second setting ranges by the first setting are acquired from these tables. For example, when the first setting [print speed] in the table E shown in FIG. 11A is “constant speed”, if the second setting [image quality]=“5” is set, no value to be assumed is available for the corresponding third setting [power consumption]. For this reason, at this time, the second setting [image quality]=5 is excluded from options. When the first setting [print speed] is “half speed” in the table E, if the second setting [image quality]=“5” is set, since the corresponding third setting [power consumption] has to be “high”, it is automatically switched to this value.

As described above, according to this embodiment, using the second menu and setting value correlation tables, relevancies between settings intended by the user and the operations and states of the image forming apparatus are presented.

Note that the configuration of the second menu shown in FIGS. 9A to 9G is not limited to this. For example, the menu may be configured to allow the user to understand the priority levels of settings, that is, which item is the first setting. Also, a button used to reset settings may be arranged.

[Processing Sequence]

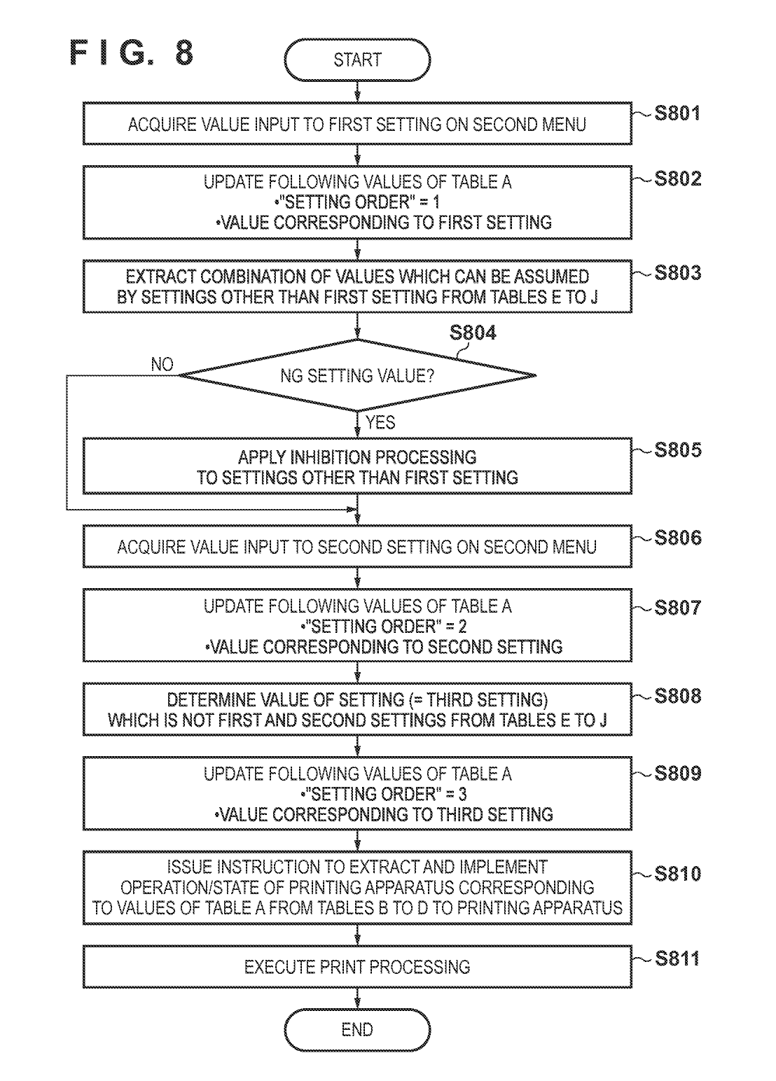

FIG. 8 shows the processing sequence. When image data is input from the image reading unit 101 or host computer 616, print processing is started. In step S801, the image processing unit 102 acquires a value input to the second menu as “first setting”. In step S802, the image processing unit 102 sets a setting order “1” (which indicates the first setting) and a changed setting value in a corresponding element field in the setting value correlation table A of the initial settings shown in FIG. 10A. In step S803, the image processing unit 102 extracts values which can be assumed by elements other than the first setting from the setting value correlation tables E to J shown in FIGS. 11A to 11C.

The image processing unit 102 judges in step S804 whether or not there is a setting NG combination after the first setting is determined. If there is a setting NG combination (YES in step S804), the image processing unit 102 applies inhibition processing to the UI to disable user selection in step S805. At this time, selection NG display can use, for example, gray-out display. If there is no setting NG combination (NO in step S804), the process advances to step S806.

In step S806, the image processing unit 102 acquires a next setting input value on the second menu as “second setting”. In step S807, the image processing unit 102 sets a setting order “2” (which indicates the second setting) and a changed setting value in a corresponding element field in the setting value correlation table A, as shown in FIG. 10C. After the first and second settings are settled, the image processing unit 102 determines a third setting (element other than the first and second settings) within a valid range of this setting value in step S808. Then, in step S809, the image processing unit 102 sets a setting order “3” (which indicates the third setting) and a changed setting value in a corresponding element field in the setting value correlation table A, as shown in FIG. 10D. In this way, the settings of all of the three elements are settled. In step S811, the image processing unit 102 sends an instruction required to set the corresponding operation and state of the image forming apparatus from the setting value correlation tables B to D shown in FIGS. 7B to 7D, thus executing print processing. After the print processing, this processing sequence ends.

With the aforementioned method, the setting processing of the fixing temperature, fixing speed, and maximum amount of applied toner, which correspond to the elements [power consumption], [print speed], and [image quality] and are correlated with each other, is executed.

A method of designating a degree of reduction (%) of power consumption from an initial setting on the second menu is also available. In this case, information as a setting value correlation table D′ shown in FIG. 7E is provided, and the second menu can have UI screen configurations shown in FIGS. 9E and 9F. A power consumption setting in FIGS. 9E and 9F includes an item 904 used to designate a reduction ratio. On the initial setting shown in FIG. 9E, the fixing temperature is set to be 220° C. which is the same as “high” in the setting value correlation table D shown in FIG. 7D. By contrast, when a reduction ratio=“20%” of [power consumption] is designated, as shown in FIG. 9F, the corresponding setting value is “200° C.” (which is the same as “middle” in the setting value correlation table D), as can be seen from the setting value correlation table D′. Therefore, as can be seen from FIG. 11C, since [image quality]=“4” and [print speed]=“constant speed” of the current settings are not valid, [image quality] is changed to “3” in this example, as shown in FIG. 9F, so as to cope with that designation.

After that, when the user changes [image quality] to “4” again, this setting is considered as the second setting after the first setting [power consumption], and [print speed] is changed to “half speed” to cope with this change. In the processing sequence shown in FIG. 8, values are stored in the setting value correlation table A in one of steps S802, S807, and S809, and the setting value correlation table D′ is referred to in step S810.

Furthermore, by providing a switch which enables the current menu settings only within a specific time period to the second menu, for example, settings which prioritize power consumption in a power consumption peak time zone can be selected as a basic state. FIG. 9G shows an example of a UI screen having an item [automatic setting time] which allows the user to set start and end times in which the settings on the menu are enabled. When the user inputs start and end times in [automatic setting time] and presses an automatic setting time button 905, setting values on the second menu at that time are stored together with time information while “10-12” is set in [setting time] in the setting value correlation table A (FIG. 10E). After that, this information is not changed even when the settings on the menu are changed. When a time corresponding to the start time is reached in the timer 615 in the image forming apparatus, the respective pieces of information of the corresponding setting value correlation table A are read out from the internal storage area unit 603, thus executing the same processing.

### Third Embodiment

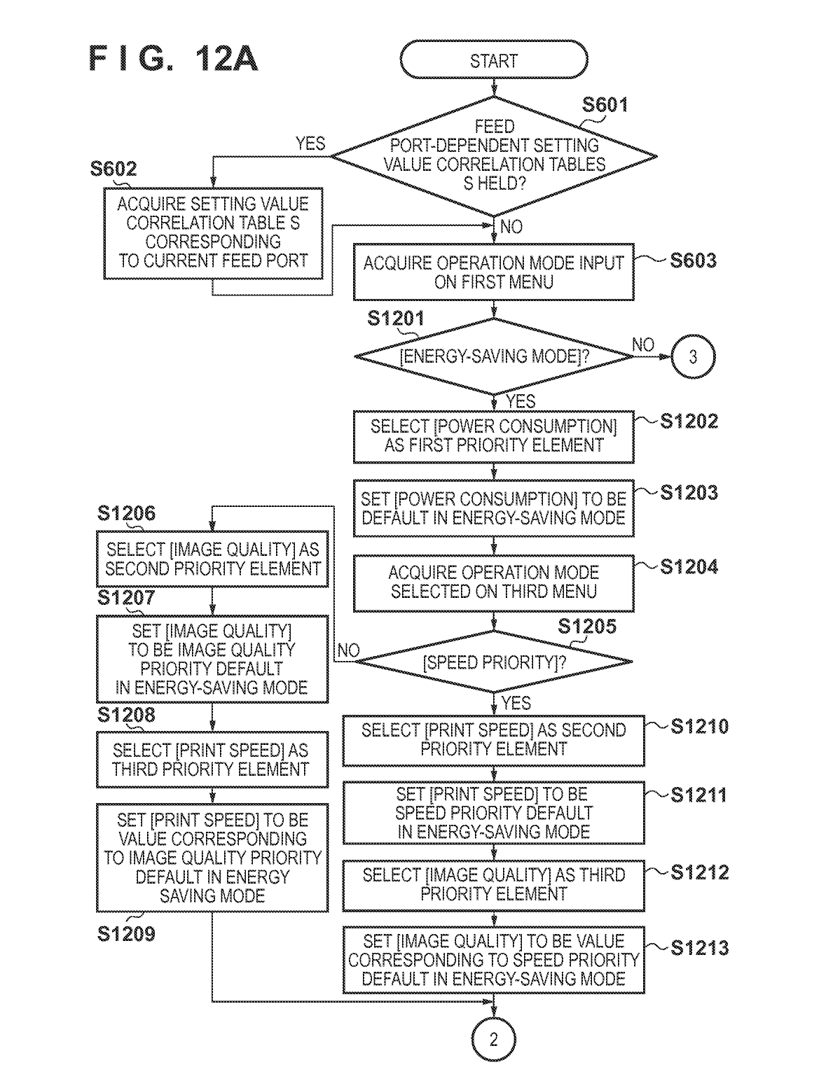

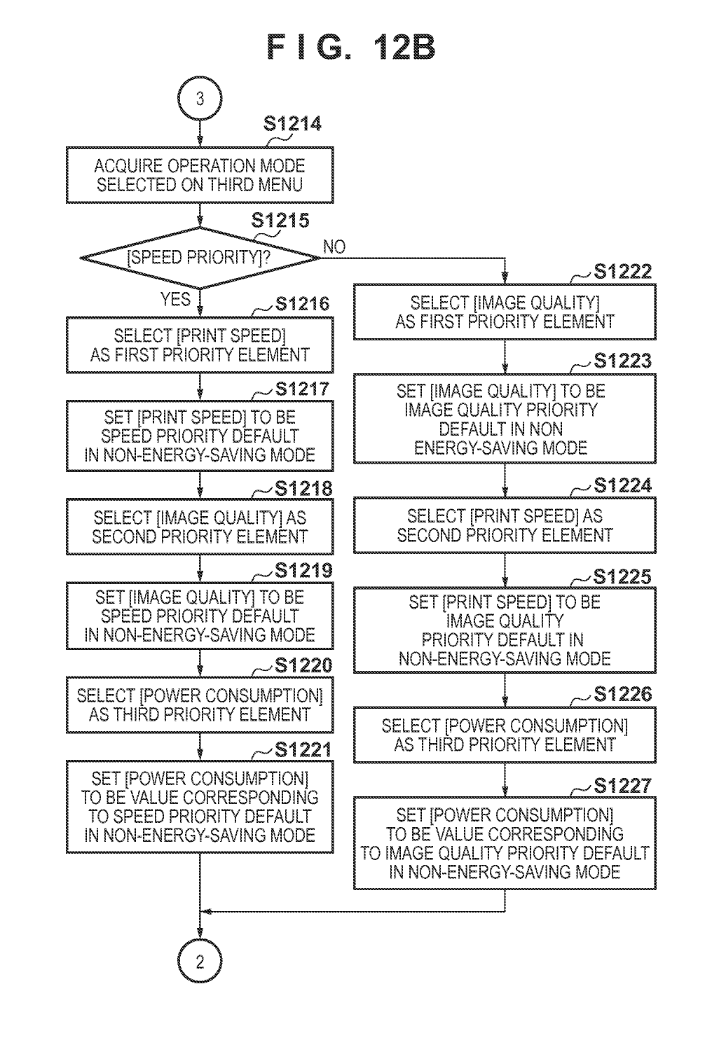

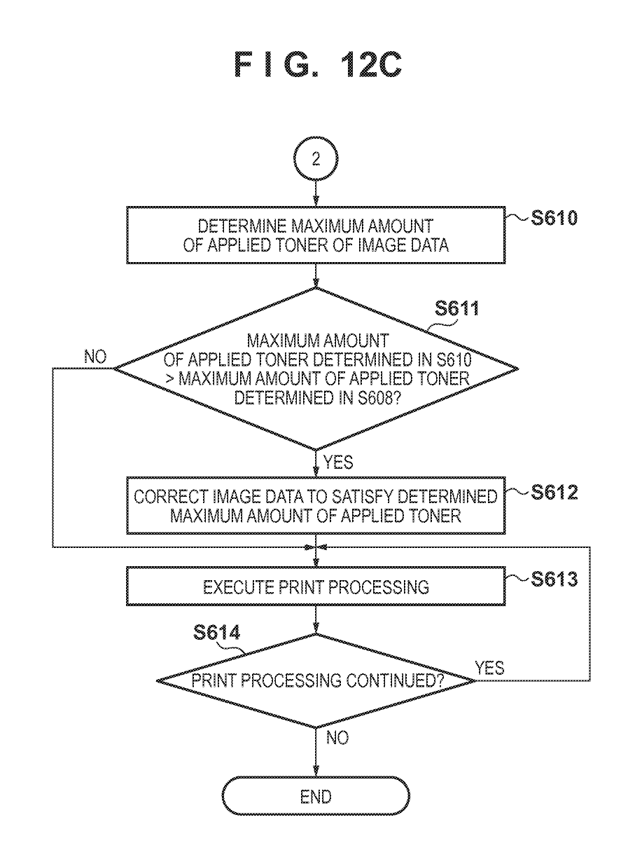

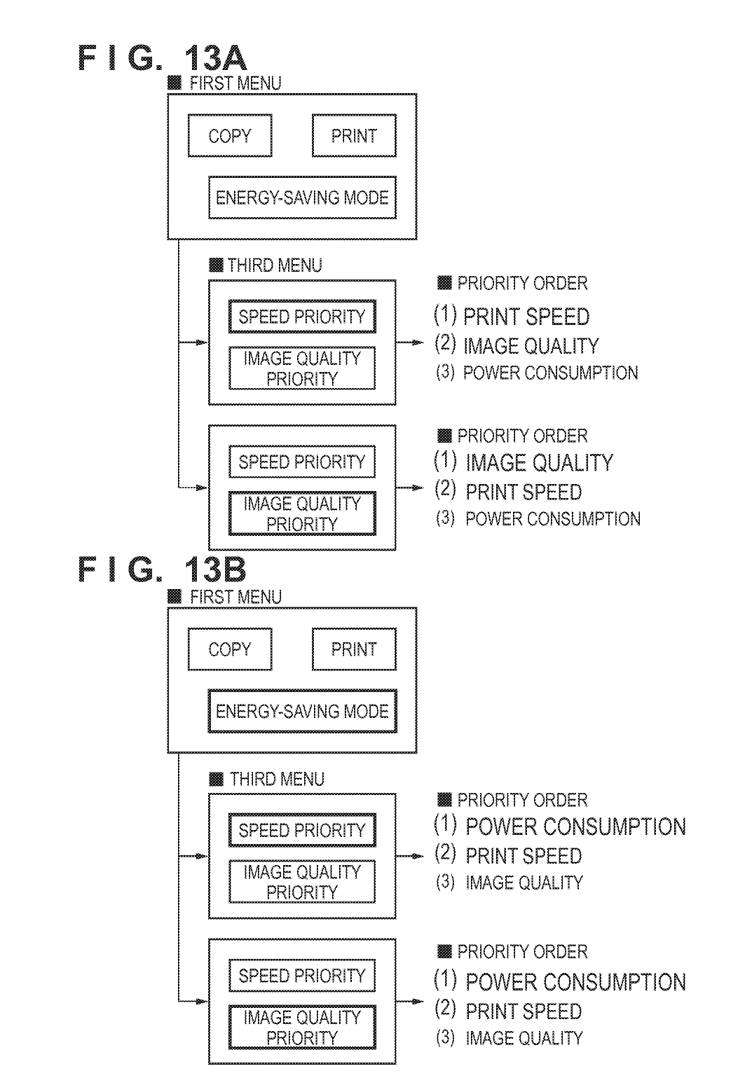

The third embodiment will be described in detail below with reference to FIGS. 12 to 14D. FIGS. 13A and 13B show the first menu described in the first embodiment, and also a third menu used to switch an operation mode to [speed priority] or [image quality priority]. FIG. 13A shows a case in which [energy-saving mode] is not input on the first menu. At this time, if the user inputs [speed priority] on the third menu, the priority order is uniquely determined to be 1. [print speed], 2. [image quality], and 3. [power consumption]. If the user inputs [image quality priority] on the third menu, the priority order is uniquely determined to be 1. [image quality], 2. [print speed], and 3. [power consumption].

On the other hand, FIG. 13B shows a case in which [energy-saving mode] is input on the first menu. At this time, if the user inputs [speed priority] on the third menu, the priority order is uniquely determined to be 1. [power consumption], 2. [print speed], and 3. [image quality]. Also, if the user inputs [image quality priority], the priority order is uniquely determined to be 1. [power consumption], 2. [image quality], and 3. [print speed].

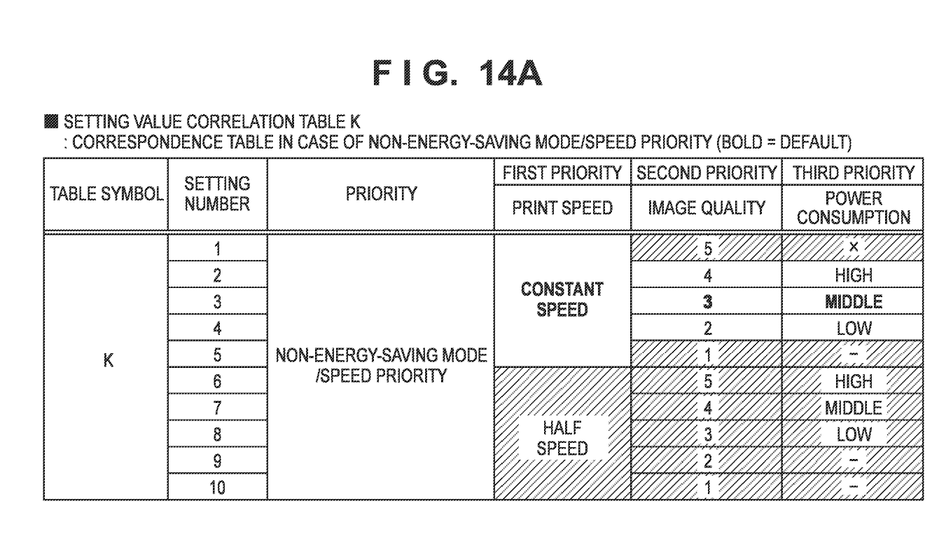

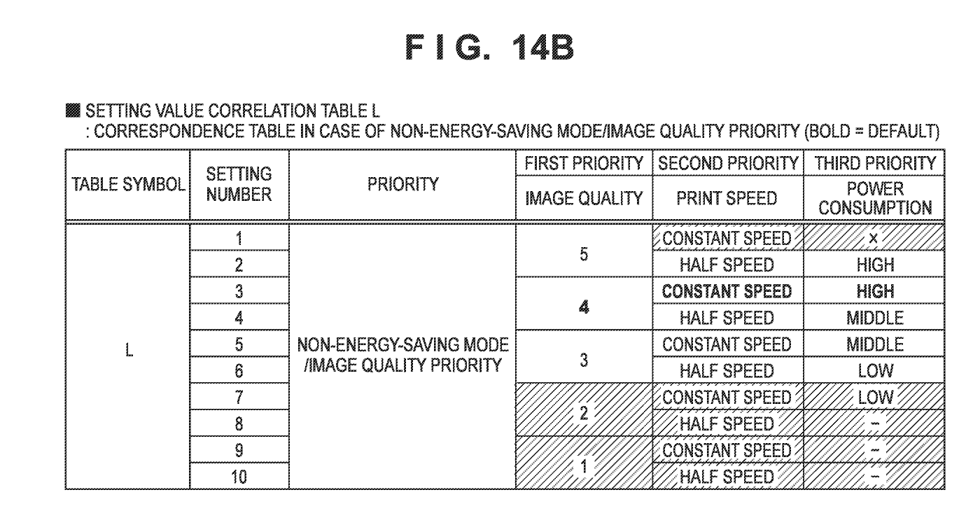

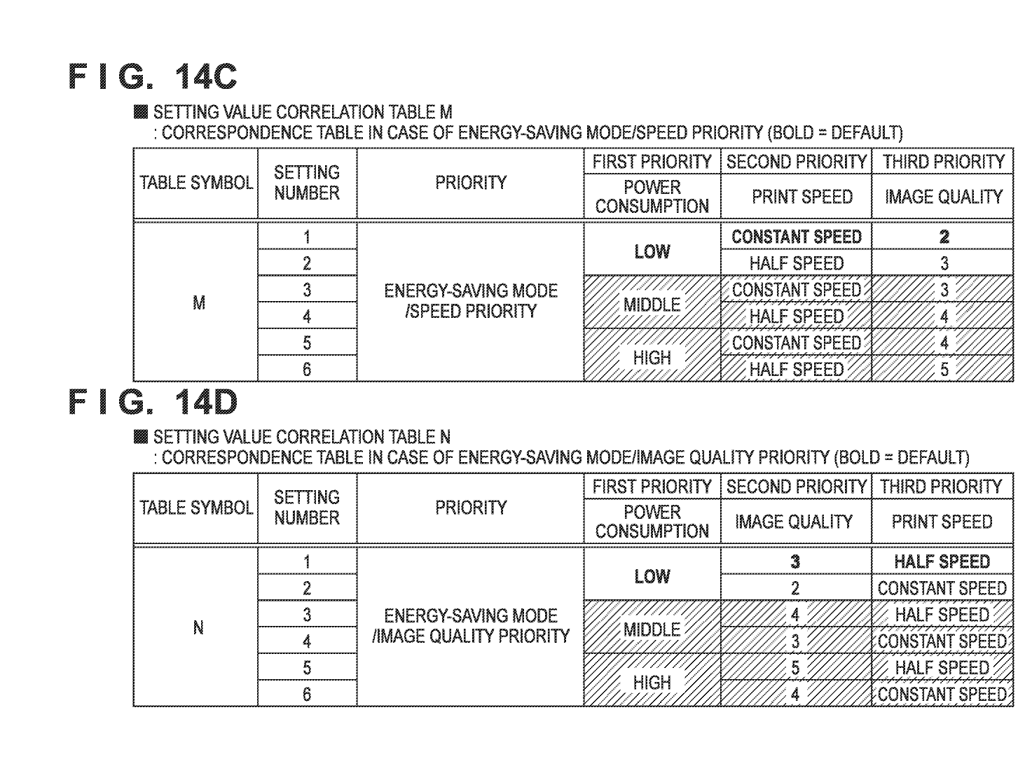

According to the priority order determined on this menu, setting values are determined using any of setting value correlation tables K to N shown in FIGS. 14A to 14D. That is, in the menu state shown in FIG. 13A, a setting value correlation table K (FIG. 14A) or setting value correlation table L (FIG. 14B) is selected, and respective setting values are determined according to the priority order. Likewise, in the menu state shown in FIG. 13B, a setting value correlation table M (FIG. 14C) or setting value correlation table N (FIG. 14D) is selected, and respective setting values are determined according to the priority order.

These first and third menus implement an accepting unit which accepts the priority order of settings.

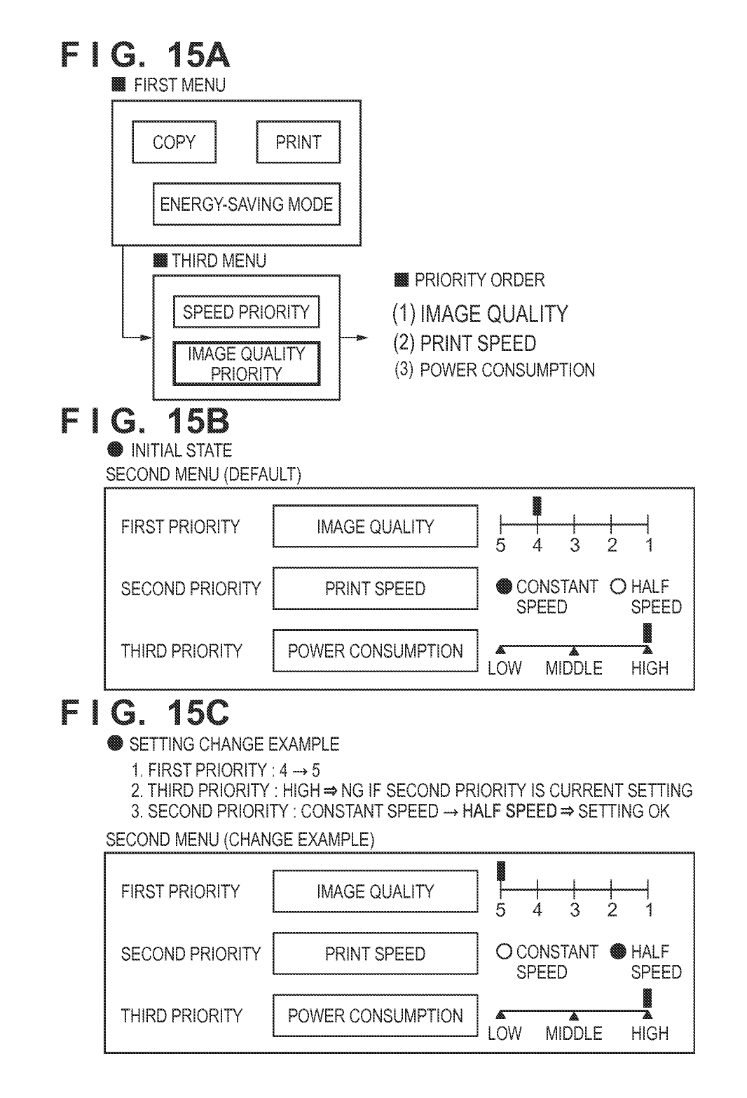

A case will be exemplified below with reference to FIGS. 15A to 15C wherein as a result of a manual change of a first priority setting, a second priority setting is automatically changed. FIG. 15A shows first and third panel settings. In this case, an input value to the first menu is [non-energy-saving mode] and an input value to the third menu is [image quality priority]. For this reason, the priority order is determined to be 1. [image quality], 2. [print speed], and 3. [power consumption], and corresponding setting values are determined using the setting value correlation table L shown in FIG. 14B. FIG. 15B shows an initial state of setting values. Note that the initial state is not limited to these values, and the user may define the initial state in advance.

Assume that the user changes the value of [image quality] from “4” to “5” on the second menu from the initial state shown in FIG. 15B. As can be seen from FIG. 14B, when [image quality] of the setting value correlation table L is “5”, a combination including [print speed]=“constant speed” as the second priority is NG. Therefore, in order to validate this combination, [print speed] as the second priority is automatically set to be “half speed”, thus changing the second menu to a state shown in FIG. 15C.

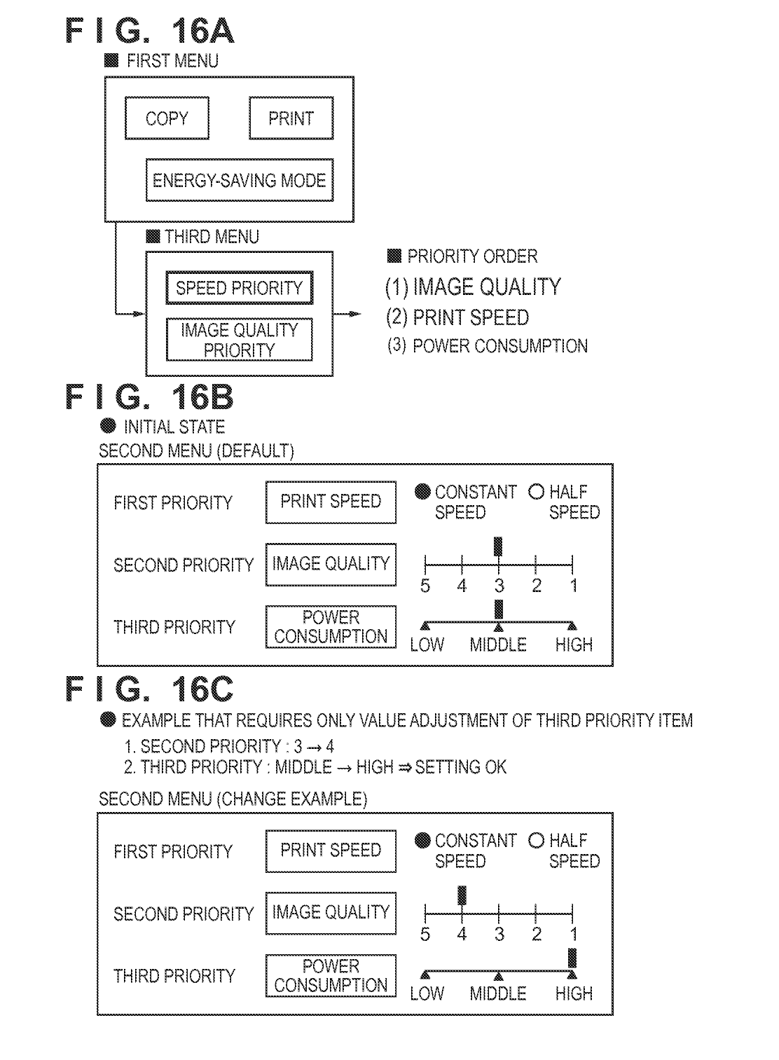

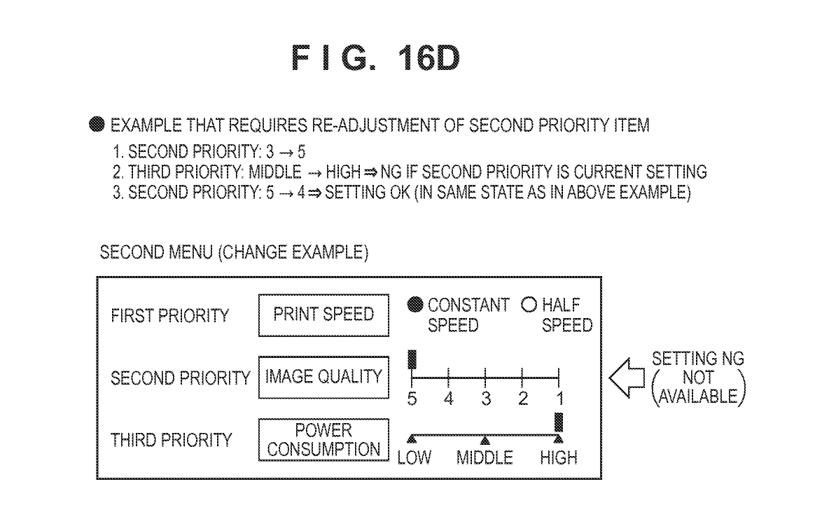

Another example will be described below with reference to FIGS. 16A to 16D. In this example, a case will be explained below wherein as a result of a manual change of the second priority setting, a third priority setting is automatically changed. FIG. 16A shows the first and third panel settings. In FIG. 16A, an input value to the first menu is [non-energy-saving mode], and an input value to the third menu is [speed priority]. For this reason, the priority order is determined to be 1. [print speed], 2. [image quality], and 3. [power consumption], and corresponding setting values are determined using the setting value correlation table K shown in FIG. 14A.

Assume that the user changes the value of [image quality] from “3” to “4” on second menu from the initial state shown in FIG. 16B. As can be seen from FIG. 14A, when the [print speed] is “constant speed” and [image quality] is “4” in the setting value correlation table K, [power consumption] as the third priority has to be “high”. Therefore, [power consumption] as the third priority is automatically set from “middle” to “high”, thus changing the second menu to a state shown in FIG. 16C.

On the other hand, assume that the user changes the value of [image quality] from “3” to “5” on the second menu from the initial state shown in FIG. 16B. At this time, as can be seen from the setting value correlation table K in FIG. 14A, when [print speed] is “constant speed” and [image quality] is “5”, even when [power consumption] as the third priority is “high”, this combination is NG. Therefore, the second menu shown in FIG. 16D is not available. Therefore, in order to validate this combination, [image quality] as the second priority is automatically re-set from “5” to “4”, thus changing the second menu to a state shown in FIG. 16C.

[Processing Sequence]

FIGS. 12A, 12B, and 12C are flowcharts showing the processing. A method of determining setting values of respective elements using only the first and third menus will be described first. When the processing starts, the image processing unit 102 acquires an operation mode input in the first menu as in steps S601 to S603 in the processing sequence (FIG. 6A) described in the first embodiment. Since the processes in these steps are the same as those in the first embodiment, a description thereof will not be repeated.

The image processing unit 102 checks in step S1201 whether or not an input value is [energy-saving mode]. If the input value is [energy-saving mode] (YES in step S1201), the image processing unit 102 selects [power consumption] as a first priority element in step S1202. Then, in step S1203, the image processing unit 102 sets a default value (“low” in this example) of [power consumption] using the setting value correlation table M/N shown in FIG. 14C or 14D.

In step S1204, the image processing unit 102 acquires an operation mode selected on the third menu. The image processing unit 102 checks in step S1205 whether or not the acquired operation mode is [speed priority]. If the acquired operation mode is [speed priority] (YES in step S1205), the image processing unit 102 selects [print speed] as a second priority element in step S1210. Then, it is determined that the setting value correlation table M shown in FIG. 14C is to be referred to. In this example, a default value of [print speed] is “constant speed” (setting number 1). Thus, the image processing unit 102 sets this value in step S1211. In step S1212, the image processing unit 102 selects [image quality] as a third priority element. Likewise, the image processing unit 102 sets a value (“2” in this example) of [image quality] corresponding to [energy-saving mode] and [print speed], which are set previously from the setting number 1 of the setting value correlation table M.

On the other hand, if the operation mode selected on the third menu is [image quality priority] (NO in step S1205), the image processing unit 102 selects [image quality] as a second priority element in step S1206. Then, it is determined that the setting value correlation table N in FIG. 14D is to be referred to.

In this example, a default value of [image quality] is “3” (setting number 1). Thus, the image processing unit 102 sets this value in step S1207. In step S1208, the image processing unit 102 selects [print speed] as a third priority element. In step S1209, the image processing unit 102 sets a value (“half speed” in this example) corresponding to [energy-saving mode] and [image quality], which are set previously, from the setting number 1 of the setting value correlation table N.

If it is determined in step S1201 that the input value is not [energy-saving mode] (NO in step S1201), the image processing unit 102 acquires an operation mode selected on the third menu as a first priority element in step S1214. The image processing unit 102 checks in step S1215 whether the selected operation mode is [speed priority] or [image quality priority]. If the selected operation mode is [speed priority] (YES in step S1215), the image processing unit 102 selects [print speed] as a first priority element in step S1216. Then, the image processing unit 102 sets a default value (“constant speed” in this example) of [print speed] from the setting value correlation table K shown in FIG. 14A in step S1217. Thus, the image processing unit 102 determines [image quality] as a second priority element in step S1218. In step S1219, the image processing unit 102 sets a default value (“3” in this example, setting number 3) of [image quality].

In step S1220, the image processing unit 102 selects [power consumption] as a third priority element. In step S1221, the image processing unit 102 sets a default value (“middle” in this example) in [non-energy-saving mode] from the setting number 3 of the setting value correlation table K.

On the other hand, if it is determined in step S1215 that the selected operation mode is [image quality priority] (NO in step S1215), the image processing unit 102 selects [image quality] as a first priority element in step S1222. Then, the image processing unit 102 sets a default value (“4” in this example, setting number 3) of [image quality] from the setting value correlation table L shown in FIG. 14B in step S1223. Thus, the image processing unit 102 determines [print speed] as a second priority element in step S1224. In step S1225, the image processing unit 102 sets a default value (“constant speed” in this example) of [print speed].

In step S1226, the image processing unit 102 selects [power consumption] as a third priority element. In step S1227, the image processing unit 102 sets a default value (“high” in this example) in [non-energy-saving mode] from the setting number 3 of the setting value correlation table L.

Then, the image processing unit 102 predicts a maximum amount of applied toner of image data and executes print processing as in steps S610 to S614 in FIG. 6B. Note that the processes in these steps are the same as those in the first embodiment, and a description thereof will not be repeated.

The method of determining the respective elements when the values on the first and third menus are determined has been described. In addition, the same sequence can be executed even when a setting change is made on the second menu. That is, in the steps of setting values of the respective elements, the value set on the second menu and that which is determined in synchronism with that value are selected and used from the setting value correlation tables K to N in place of the default values of the setting value correlation tables K to N. The steps of setting the values of the respective elements correspond to, for example, steps S1203, S1207, S1209, S1211, S1213, S1217, S1219, S1221, S1223, S1225, S1227, and the like.

Thus, a unit which allows the user to prioritize functions provided by the apparatus can be provided.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-218326, filed Sep. 30, 2011, which is hereby incorporated by reference herein in its entirety.

What is claimed is:

1. An image processing apparatus, which controls a fixing temperature and a fixing speed of a fixing device used to fix a formed image, and a color material amount used to form the image, said apparatus comprising:
a display unit configured to display an operation panel which accepts settings associated with the fixing temperature, the fixing speed, and the color material amount for image forming processing; and
a determination unit configured to determine, in a case where settings of two items out of the fixing temperature, the fixing speed, and the color material amount are accepted via the operation panel, a setting of the remaining one item.

2. The apparatus according to claim 1, further comprising a holding unit configured to hold correlation information indicating settable value ranges based on a relationship among the settings of the fixing temperature, the fixing speed, and the color material amount for the image forming processing,
wherein said determination unit determines the setting of the remaining one item with reference to the correlation information.

3. The apparatus according to claim 1, further comprising a unit configured to control the fixing device based on the fixing temperature and the fixing speed determined by said determination unit.

4. The apparatus according to claim 1, further comprising a unit configured to control a color material amount used to form the image based on the setting value of the color material amount determined by said determination unit.

5. The apparatus according to claim 1, wherein the setting associated with the fixing temperature is a power consumption setting.

6. The apparatus according to claim 1, wherein the setting associated with the fixing speed is a print speed setting.

7. The apparatus according to claim 1, wherein the setting associated with the color material amount is an image quality setting.

8. An image processing apparatus, which controls a fixing temperature and a fixing speed of a fixing device used to fix a formed image, and a color material amount used to form the image, said apparatus comprising:
a display unit configured to display an operation panel which accepts settings associated with the fixing temperature, the fixing speed, and the color material amount for image forming processing;
a determination unit configured to determine, in a case where a setting of one item out of the fixing temperature, the fixing speed, and the color material amount are accepted via the operation panel, setting ranges of setting values of the remaining two items; and
a control unit configured to control displayed contents of the operation panel by said display unit so as not to allow to select setting values falling outside the setting ranges determined by said determination unit.

9. The apparatus according to claim 8, further comprising an input unit configured to input setting values of the remaining two items from the setting ranges determined by said determination unit via the operation panel.

10. A control method in an image processing apparatus, which controls a fixing temperature and a fixing speed of a fixing device used to fix a formed image, and a color material amount used to form the image, the method comprising the steps of:
displaying an operation panel which accepts settings associated with the fixing temperature, the fixing speed, and the color material amount for image forming processing; and
determining, in a case where settings of two items out of the fixing temperature, the fixing speed, and the color material amount are accepted via the operation panel, a setting of the remaining one item.

11. A control method in an image processing apparatus, which controls a fixing temperature and a fixing speed of a fixing device used to fix a formed image, and a color material amount used to form the image, the method comprising the steps of:
displaying an operation panel which accepts settings associated with the fixing temperature, the fixing speed, and the color material amount for image forming processing;
determining, in a case where a setting of one item out of the fixing temperature, the fixing speed, and the color material amount are accepted via the operation panel, setting ranges of setting values of the remaining two items; and
controlling displayed contents of the operation panel in the display step so as not to allow to select setting values falling outside the setting ranges determined in the determination step.

12. A non-transitory computer-readable medium storing a program for controlling a computer to function as:
a display unit configured to display an operation panel which accepts settings associated with a fixing temperature, a fixing speed, and a color material amount for image forming processing; and
a determination unit configured to determine, in a case where settings of two items out of the fixing temperature, the fixing speed, and the color material amount are accepted via the operation panel, a setting of the remaining one item.

13. A non-transitory computer-readable medium storing a program for controlling a computer to function as:
a display unit configured to display an operation panel which accepts settings associated with a fixing temperature, a fixing speed, and a color material amount for image forming processing;
a determination unit configured to determine, in a case where a setting of one item out of the fixing temperature, the fixing speed, and the color material amount are accepted via the operation panel, setting ranges of setting values of the remaining two items; and
a control unit configured to control displayed contents by said display unit so as not to allow to select setting values falling outside the setting ranges determined by said determination unit.
